(19) United States
(12) Patent Application Publication
(10) Pub. No.: US 2026/0361576 A1
(43) Pub. Date: Nov. 12, 2026

(54) Deep Learning Based Channel Estimation

(71) Applicants: Vestel Elektronik Sanayi ve Ticaret A. S., Manisa (TR); Koc University, Sariyer (TR)

(72) Inventors: Ali Tugberk Dogukan, Sariyer (TR); Burak Özpoyraz, Sariyer (TR); Ertugrul Basar, Sariyer (TR); Basak Özbakis, Manisa (TR)

(21) Appl. No.: 19/121,700

(22) PCT Filed: Oct. 17, 2022
(86) PCT No.: PCT/EP2022/078823

§ 371 Date: Apr. 16, 2025

(51) Int. Cl. H04L 25/02

(52) U.S. Cl. CPC H04L 25/0254; H04L 25/0224

(57) ABSTRACT

Some embodiments in the present disclosure relate to obtaining a channel estimation for a wireless channel. An initial channel estimation is obtained based on a received wireless signal. The initial channel estimation is processed by a classifier neural network, including obtaining a class of the wireless channel. A refinement neural network is selected according to the obtained class. The initial channel estimation is processed by the selected refinement neural network to obtain a refined channel estimation.

### CROSS-REFERENCE TO RELATED APPLICATION

This application is the United States national phase of International Patent Application No. PCT/EP2022/078823 filed Oct. 17, 2022, the disclosure of which is hereby incorporated by reference in its entirety.

### BACKGROUND

### Technical Field

The present disclosure relates to channel estimation for a wireless channel. In some non-limiting examples, the present disclosure provides methods and apparatuses for obtaining such a channel estimation.

### Technical Considerations

Wireless communication has been advancing over several decades now. Exemplary notable standards organizations comprise the 3rd Generation Partnership Project (3GPP) and IEEE 802.11, commonly referred to as Wi-Fi. A wireless communication signal gets distorted or various noise is added to the signal while the signal goes through a wireless channel. Wireless communication signals may be distorted due to scattering, fading, power decay with distance and/or the like. To properly decode the received signal, the distortion and noise applied by the channel are to be removed from the received signal. A first step is to figure out the characteristics of the channel that the signal has gone through. The technique/process to characterize the channel is called channel estimation. Channel estimation facilitates a reconstruction of the received signal and/or an adaption of a transmitted signal by estimating the channel properties of a communication link. For example, channel estimation is based on the reconstruction of known signals such as pilot symbols.

### SUMMARY

The present disclosure relates to methods and apparatuses for channel estimation for a wireless channel.

According to some non-limiting embodiments, a method is provided for channel estimation for a wireless channel, comprising: obtaining an initial channel estimation based on a wireless signal received over the wireless channel; processing the initial channel estimation by a classifier neural network comprising obtaining a class of the wireless channel; selecting a refinement neural network from a plurality of refinement neural networks based on the obtained class; and obtaining a refined channel estimation comprising processing the initial channel estimation by the selected refinement neural network.

According to some non-limiting embodiments, an apparatus is provided for channel estimation for a wireless channel, the apparatus comprising processing circuitry configured to: obtain an initial channel estimation based on a wireless signal received over the wireless channel; process the initial channel estimation by a classifier neural network comprising obtaining a class of the wireless channel; select a refinement neural network from a plurality of refinement neural networks based on the obtained class; and obtain a refined channel estimation comprising processing the initial channel estimation by the selected refinement neural network.

These and other features and characteristics of the presently disclosed subject matter, as well as the methods of operation and functions of the related elements of structures and the combination of parts and economies of manufacture, will become more apparent upon consideration of the present disclosure. It is to be expressly understood, however, that the drawings are for the purpose of illustration and description only and are not intended as a definition of the limits of the disclosed subject matter. As used in the present disclosure, the singular form of “a,” “an,” and “the” comprise plural referents unless the context clearly dictates otherwise.

### BRIEF DESCRIPTION OF THE DRAWINGS

An understanding of the nature and advantages of various embodiments may be realized by reference to the following figures.

The terms Fig., Figs., Figure, and Figures are used interchangeably in the specification to refer to the corresponding figures in the drawings.

FIG. 1 is a block diagram illustrating a basic communication system;

FIG. 2 is a block diagram illustrating an exemplary neural network;

FIG. 3 is a block diagram illustrating a transmission over a wireless channel;

FIG. 4 is a flowchart illustrating an exemplary channel estimation;

FIG. 5 is a block diagram illustrating the obtaining and refining of a channel estimation;

FIG. 6 is a block diagram illustrating an exemplary apparatus for sensing signal sharing; and

FIG. 7 is a block diagram illustrating an exemplary memory for an apparatus transmitting a sensing signal.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to comprise one or more items and may be used interchangeably with “one or more” and “at least one.” Furthermore, as used herein, the term “set” is intended to comprise one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

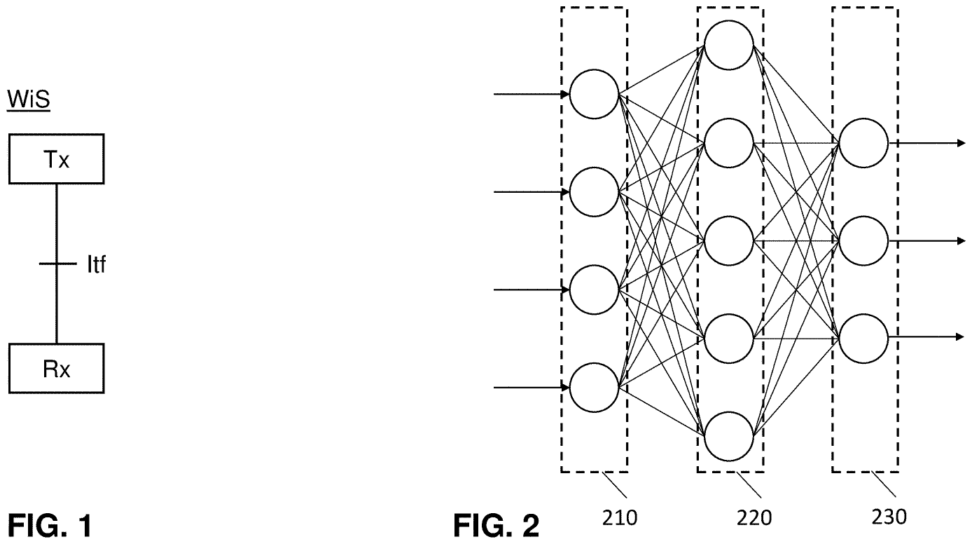

FIG. 1 illustrates an exemplary wireless system WiS in which Tx represents a transmitter and Rx represents a receiver of the wireless signal. The transmitter Tx is capable of transmitting a signal to the receiver Rx or to a group of receivers or to broadcast a signal over an interface Itf. The interface may be any wireless interface. The interface may be specified by means of resources, which can be used for the transmission and reception by the transmitter Tx and the receiver Rx. Such resources may be defined in one or more (or all) of the time domain, frequency domain, code domain, and space domain. There may be separate devices comprising the functionality of the Rx and Tx, respectively. The transmitter Tx and receiver Rx may be implemented in any device such as a base station (eNB, AP) or terminal (UE, STA), or in any other entity of the wireless system WiS. A device such as a base station, access point, or terminal may implement both Rx and Tx. It is noted that in general, the “transmitter” and “receiver” may be also both integrated into the same device. In other words, the devices Tx and Rx in FIG. 1 may respectively also comprise the functionality of the Rx and Tx, respectively.

The present disclosure is not limited to any particular transmitter Tx, receiver Rx and/or interface Itf implementation. However, it may be applied readily to some existing communication systems as well as to the extensions of such systems, or to new communication systems. Exemplary existing communication systems may be, for instance the 5G New Radio (NR) in its current or future releases, and/or the IEEE 802.11 based systems such as the recently studied IEEE 802.11be or the like. The wireless signal is not necessarily a communication signal in the sense that it does not necessarily carry out human or machine communication. It may be, for example, a sensing signal such as a radar signal or sounding a signal or any other kind of wireless signal from a wireless device such as, for example, some signal reporting (sensing) results to another device(s).

The present disclosure is also applicable to other communication technologies such as 3G, communication technologies under long-term evolution (LTE)/LTE Unlicensed (LTE-U) or future communication technologies such as 6G standards or other future standards.

Orthogonal frequency division multiplexing (OFDM) is an example for a multicarrier waveform and has been used in numerous standards such as long-term evolution (LTE) and the IEEE 802.11 family due to its simple and effective structure. Owing to the overlapped orthogonal subcarriers, OFDM may use the spectrum efficiently. Moreover, the time frequency grid of OFDM allows for a flexible use of resource elements.

In some non-limiting embodiments of an OFDM system, modulated data symbols for each data subcarrier are determined in the frequency domain by mapping information bits to the phase-shift keying (PSK)/quadrature amplitude modulation (QAM) constellation. A predetermined number of subcarriers are allocated for the transmission of pilot symbols (reference signals) to perform channel estimation. Channel coefficients may be estimated in the time-domain or frequency-domain. In the frequency domain, the channel frequency response is, for example, estimated by exploiting pilot symbols and may be interpolated to obtain the channel frequency response over data symbols.

The present disclosure is not limited to OFDM systems. Any system may be used that comprises reference signals in a transmitted signal.

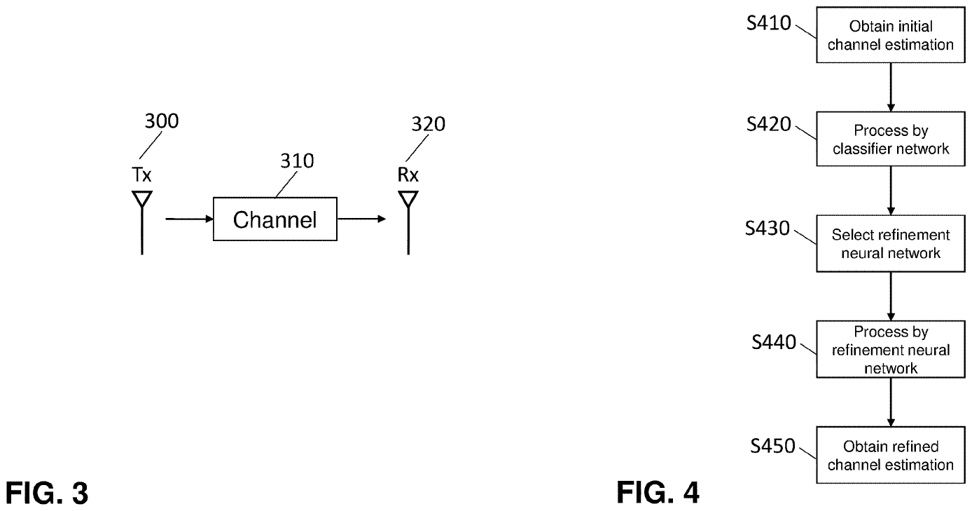

In such a transmission, a wireless signal x propagates from a transmitter 300 through a wireless channel H 310 to a receiver 320, as exemplarily shown in FIG. 3. The transmitter 300 may be a transmitter Tx, as described above with reference to FIG. 1. Similarly, the receiver 320 may be a receiver Rx, as shown in FIG. 1. Such a wireless channel 310 may be, for example, an IEEE 802.11 based wireless channel, a 5G New Radio (NR) based wireless channel or any other wireless channel. The transmitter 300 can have one or more transmission antennas. The receiver 320 can have one or more receiver antennas.

To properly demodulate the received wireless signal y, the effects of the channel such as, for example, scattering, fading, power decay with distance and/or the like, are taken into account. The characteristics of the wireless channel 310 are obtained by a channel estimation. Channel estimation facilitates a reconstruction of the received signal and/or an adaption of a transmitted signal by estimating the channel properties of a communication link. For example, channel estimation is based on the reconstruction of reference signals known at both transmitter 300 and receiver 320. Reference signals are sometimes also referred to as pilot symbols.

In an exemplary linear channel model, a received signal, denoted by vector y depends on a transmitted signal, denoted by vector x, by

y=Hx+n,

where H is a so-called channel matrix and n is a noise vector. Such a noise vector may be modeled for example, by statistical types of noise such as white noise, Gaussian noise, or the like.

The components of said vector refer to subcarriers in the frequency domain. The frequency-domain input-output relationship for OFDM signal may be written as:

y(a)=h(a)x(a)+n(a)

where a is subcarrier index.

Channel estimation may be performed based on a transmitted reference signal, denoted by vector xₚ and a corresponding received signal, denoted by vector yₚ. Such a received reference signal yₚ may be comprised in the received signal y. The channel estimation here is estimation of elements of matrix H.

A channel estimation comprises an estimate Ĥ for the channel matrix H. For example, a least squares (LS) method or a linear minimum mean square error (LMMSE) method may be applied to obtain a channel estimation.

In an exemplary (least squares) implementation, a channel estimation ĥ_{LS} is obtained from a received pilot symbol vector yₚ and a transmitted pilot symbol vector xₚ by

$${\hat{h}}_{LS} ( p ) = \frac{{y}_{P} ( p )}{{x}_{P} ( p )} ,$$

where xₚ(p) and yₚ(p) are the transmitted pilot symbol and the corresponding received symbol at the p-th pilot subcarrier index. The pilot subcarrier index p may be chosen, for example, in the range from 1 to the number of subcarriers. The obtained values ĥ_{LS}(p) denote to the diagonal elements of the estimate Ĥ.

The pilot symbols may be continuous pilot symbols, or scattered pilot symbols or a combination thereof.

The remaining elements of Ĥ are estimated based on the calculated values of ĥ_{LS}(k). Such estimation may comprise an interpolation or the like.

Such a linear channel estimation provides a way to obtain a signal reconstruction. However, a channel estimation as described above may not yield a suitable estimation for all frequencies, channel environments, channel impairments or the like. Thus, a refinement of the channel estimation may be desirable.

Deep learning (DL) has proven its unprecedented success in various fields such as computer vision, natural language processing, and speech recognition by its strong representation ability and ease of computation. New applications and use-cases for deep learning approaches have been emerging with the requirements for next-generation wireless communications. Thus, neural networks may be used, for example, for channel estimation. For example, one or more neural networks may be applied to obtain a refined channel estimation.

An artificial neural network (ANN) is based on a collection of connected units or nodes called artificial neurons, which loosely model the neurons in a biological brain. Each connection can transmit a signal to other neurons. An artificial neuron receives and processes a signal and may signal its output to neurons connected to it.

Such a “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer) to the last layer (the output layer), comprising passing of one or more hidden layers.

Fully connected neural networks (FCNNs) are an exemplary type of artificial neural network where the architecture is such that each node in one layer is connected to all of the nodes in the next layer.

A feed forward neural network (FNN) is another exemplary type of artificial neural network wherein connections between the nodes do not form a cycle. A feed forward network defines a mapping y=f(x; θ) and learns the value of the parameters θ that results in the best function approximation. These models are called feedforward because information flows through the function being evaluated from x, through the intermediate computations used to define f, and finally to the output y. There are no feedback connections in which outputs of the model are fed back into itself. When feedforward neural networks are extended to comprise feedback connections, such networks are called recurrent neural networks.

A Multi-Layer Perceptron (MLP) is an example of such a fully connected neural network. A MLP is a supplement of feedforward neural network. An MLP, exemplarily shown in FIG. 2 consists of at least three layers of nodes: an input layer 210, at least one hidden layer 220 and an output layer 230. Except for the input nodes, each node is a neuron that uses a nonlinear activation function. MLP utilizes a supervised learning technique called backpropagation for training. It can distinguish data that is not linearly separable. The major use cases of MLP are pattern classification, recognition, prediction and approximation.

As described above, a channel estimation may be obtained and/or refined by applying one or more neural networks. Such a channel estimation may be further refined by considering, for example, properties of the channel environment such as non-line-of-sight (NLOS) conditions or line-of-sight (LOS) conditions, a delay spread, or any other transmission properties. A channel estimation obtained from a processing by a neural network provides a non-linear model (estimate) of said channel.

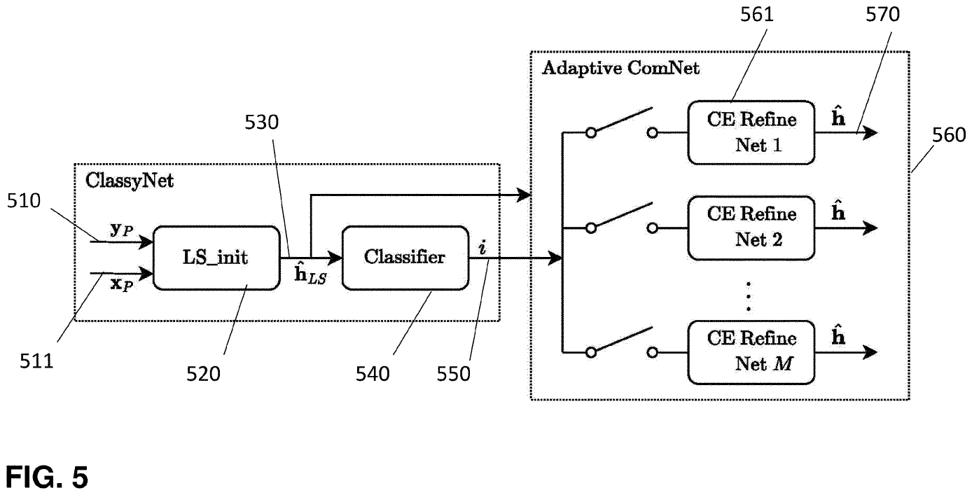

An obtaining and refining of a channel estimation comprising at least two neural networks is exemplarily illustrated in the flowchart in FIG. 4 and in FIG. 5. A channel estimation for a wireless channel 310 is obtained comprising obtaining S410 an initial channel estimation 530 based on a wireless signal received over said wireless channel 310.

Such an initial channel estimation 530 may comprise processing 520 a received pilot symbol 510 from the wireless signal and a reference pilot symbol 511. For example, as explained above, the initial channel estimation 530 may be obtained by a LS method, a LMMSE method, or the like. The received pilot symbol 510 may be comprised in a pilot symbol vector, said pilot symbol vector comprising one or more pilot symbols. The received pilot symbol 510 and the reference pilot symbol 511 are, for example, OFDM pilot symbols.

As mentioned above, such initial channel estimation may not yield a suitable estimation for all frequencies, channel environments, channel impairments or the like. Thus, an initial channel estimation 530 may be refined by a neural network, which is trained to refine the initial channel estimation for a specific class (e.g., environment) of the wireless channel 310.

A wireless channel 310 may be classified into (predetermined) classes, each of those classes may be described by a model. In other words, a wireless channel 310 may be described by a (channel) model out of a plurality of models. Such a model may be adapted to properties of the wireless channel 310. For example, a model may depend on an environment of the wireless channel 310. Such an environment may comprise NLOS conditions or LOS conditions, a delay spread, or any other (predetermined) transmission properties.

Such models may be, for example, models for WLAN channels in an IEEE 802.11 based system. A first exemplary implementation comprises five channel models for wireless channels:
Model A for a typical office environment, NLOS conditions, and 50 ns root-mean-square (rms) delay spread;
Model B for a typical large open space and office environments, NLOS conditions, and 100 ns rms delay spread;
Model C for a large open space (e.g. indoor and outdoor), NLOS conditions, and 150 ns rms delay spread;
Model D, same as model C, LOS conditions, and 140 ns rms delay spread (10 dB Ricean K-factor at the first delay);
Model E for a typical large open space (indoor and outdoor), NLOS conditions, and 250 ns rms delay spread.

A second exemplary implementation comprises six channel models:
Model A (optional, should not be used for system performance comparisons), flat fading model with 0 ns rms delay spread (one tap at 0 ns delay model). This model can be used for stressing system performance, occurs small percentage of time (locations).
Model B with 15 ns rms delay spread;
Model C with 30 ns rms delay spread;
Model D with 50 ns rms delay spread;
Model E with 100 ns rms delay spread;
Model F with 150 ns rms delay spread.

The present disclosure is not limited to WLAN channels. The channel model may describe a 5G NR channel or any other wireless channel.

Thus, in order to properly refine an initial channel estimation, in some non-limiting embodiments, the wireless channel over which a signal is received is to be classified.

The initial channel estimation 530 is processed S420 by a classifier neural network 540 comprising obtaining a class 550 of the wireless channel 310. In other words, the classifier neural network 540 receives the initial channel estimation 530 as input. The classifier neural network 540 outputs a class 550 of the wireless channel 310.

Such an exemplary classifier neural network 540 comprises one or more layers. The input to the classifier neural network 540 is processed by said one or more layers. The classifier neural network 540 may be any of the neural networks described above in section Neural Networks. For example, the classifier neural network 540 may be a feed forward neural network. However, the present disclosure is not limited to these exemplary types of neural network. In general, any neural network may be applied which receives an initial channel estimation 530 as input and outputs a class 550 of the wireless channel.

There may be a plurality of classes of wireless channels. Thus, there may be a plurality of refinement neural networks 560 to properly refine the initial channel estimation for respective classes.

Based on the obtained class 550 a refinement neural network 561 is selected S430 from a plurality of refinement neural networks 560. A refined channel estimation 570 is obtained S450 comprising a processing S440 of the initial channel estimation 530 by the selected refinement neural network 561.

The selected refinement neural network 561 receives the initial channel estimation 530 as input. The refinement neural network 561 outputs a refined estimation 570 of the wireless channel 310.

In other words, the classifier neural network 540 determines which refinement neural network out of the plurality of refinement neural networks 560 is applied to the initial channel estimation 530 to obtain a refined estimation 570.

An exemplary refinement neural network 561 comprises one or more layers. The refinement neural network 561 may be any of the neural networks described herein. For example, the refinement neural network 561 may be a feed forward neural network. However, the present disclosure is not limited to these exemplary types of neural network. In general, any neural network may be applied which receives an initial channel estimation 530 as input and outputs a refined channel estimation 570.

For example, the refinement neural networks out of the plurality of refinement neural networks 560 have a same structure, comprising one or more of (i) type of the neural network, (ii) number of layers, and/or (iii) number of nodes per layer or any other property. In other words, a same untrained (initial) refinement neural network may be trained by using different training data sets to obtain the respective refinement neural networks. These obtained (trained) refinement neural networks may differ in their respective weights.

However, the present disclosure is not limited to refinement neural networks of a same structure, in principal, the structure of the refinement neural networks may be different from each other.

Each refinement neural network from the plurality of refinement neural networks 560 corresponds to a model of a wireless channel 310. In other words, the number of refinement neural networks may be chosen according to the number of channel models.

In the case of the above-explained second exemplary implementation comprising six channel models, there are six refinement neural networks within the plurality of refinement neural networks 360, i.e., M=6 in FIG. 5. The classifier neural network 540 in this exemplary implementation classifies the initial channel estimation 530 into a class 550 out of six classes to select one of the six refinement neural networks.

For example, the classifier neural network 540 is trained to obtain a class 550 of an input (initial) channel estimation 530. Such training may be based on training dataset pairs, i.e., a plurality of input channel estimations and their respective (known) classes.

A method may be provided for training a classifier neural network 540 for obtaining a class 550 of the wireless channel 310. The method comprises obtaining a training set comprising plural training data comprising input initial channel estimations, and an indication indicating the class 550 of the wireless channel 310. The obtaining of the training set may be, for example, reading of the training data from a memory or storage of any kind. The obtaining may also comprise simulating a transmission via a channel according to a model. The method may further comprise inputting the training set into the classifier neural network 540. In other words, the pairs of the initial channel estimation 530 and the class 550 are provided to the classifier neural network 540. What follows is the step of adapting parameters (weights) of the classifier neural network 540 using the inputted training set. Finally, the adapted parameters of the classifier neural network 540 are stored for use in said obtaining of a class 550 of the wireless channel 310.

In an exemplary implementation, a refinement neural network out of a plurality of refinement neural networks 560 is trained to refine the channel estimation according to a corresponding channel model. For each refinement neural network out of the plurality of refinement neural networks 560, training data for a single respective channel model may be used. Thus, instead of training one channel estimator (deep) neural network with the training samples obtained from different channel models, a plurality of refinement neural networks are trained to better generalize the data and to increase the channel estimation performance.

A method may be provided for training a refinement neural network 561 to refine an estimate of the wireless channel 310. The method comprises obtaining a training set comprising plural training data comprising (input) initial channel estimations 530, and corresponding (output) refined channel estimations 570. The obtaining of the training set may be, for example, reading of the training data from a memory or storage of any kind. The obtaining may also comprise simulating a transmission via a channel according to a model. The method may further comprise inputting the training set into the refinement neural network 561. In other words, the pairs of initial channel estimations and the refined channel estimations are provided to the refinement neural network. What follows is the step of adapting parameters (weights) of the refinement neural network using the inputted training set. Finally, the adapted parameters of the refinement neural network are stored for use in said obtaining of a refined channel estimation 570.

A compensated signal may be obtained based on the refined channel estimation 570 and the received wireless signal 510. To obtain a compensated signal a zero-forcing equalizer, which approximates the inverse of the channel using the channel estimation, a minimum mean square error MMSE equalizer, which minimizes the total power of the noise in the output, or any other equalizer may be applied.

For example, a zero-forcing equalizer uses the refined channel estimation ĥ and/or an interpolation of the refined channel estimation h, and the received data symbol vector y_{D} to obtain a compensated signal \hat{x}_{ZF}(d):

$${\hat{x}}_{ZF} ( d ) = \frac{{y}_{D} ( d )}{\hat{h} ( d )} ,$$

where d is the data subcarrier index in the frequency domain. The range of said subcarrier index may be chosen between 1 and the number of data subcarriers. The compensated signal is demodulated to obtain information comprised in said received signal.

In an exemplary implementation, after inserting pilot symbols, the time domain OFDM signal is obtained by employing the inverse fast Fourier transform (IFFT). Furthermore, a cyclic prefix (CP) may be embedded in the beginning or end of the OFDM symbol to eliminate inter-symbol interference (ISI). After adding a CP, the OFDM signal is transmitted through the wireless communication channel. At the receiver side, the CP is removed and the frequency domain OFDM signal is acquired by taking FFT. Channel estimation is performed, and equalization is applied to remove the effect of the wireless channel. Finally, the signal is demodulated to obtain information.

It is noted that although embodiments and examples of the present disclosure were provided in terms of a method above, the corresponding devices providing the functionality described by the methods are also provided. Moreover, it is noted that any of the steps described above may be comprised as code instructions in a program, which may be executed by one or more processors.

For example, a device is provided for transmitting and/or receiving sensing signals. The device may comprise a processing circuitry, which is configured to perform steps according to any of the above-mentioned methods. The device may further comprise a transceiver for performing wireless reception and/or transmission. Alternatively to the transceiver, the processing circuitry may control an external transceiver to perform wireless reception and/or transmission. The processing circuitry may receive signals from a transceiver and/or may transmit signals to a transceiver. In other words, the processing circuitry may instruct the transceiver to receive and/or transmit signals.

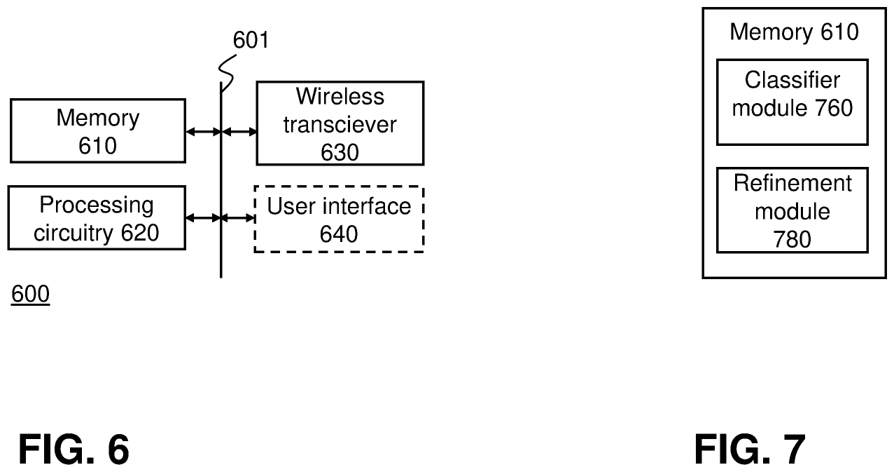

FIG. 6 shows an exemplary device 600, which may implement some embodiments of the present disclosure. Such a device may comprise memory 610, processing circuitry 620, a wireless transceiver 640, and possibly a user interface 630. The device may be, for instance a (or part of a) base station or a terminal/STA, or any other device, which receives wireless signals.

The memory 610 may store the program, which may be executed by the processing circuitry 620 to perform steps of any of the above-mentioned methods. The processing circuitry may comprise one or more processors and/or other dedicated or programmable hardware. The wireless transceiver 640 may be configured to receive and/or transmit wireless signals. The transceiver 640 may comprise also baseband processing which may detect, decode and interpret the data according to some standard or predefined convention. The device 600 may further comprise a user interface 630 for displaying messages or status of the device, or the like and/or for receiving a user's input. A bus 601 interconnects the memory, the processing circuitry, the wireless transceiver, and the user interface.

FIG. 7 provides an exemplary implementation of a memory 610, comprising classifier module 760 and a refinement module 780. It is noted that this implementation is only exemplary. There may be a different architecture for implementing the classifying or refinement, or any combination of those.

For example, the exemplary device 600 may be configured to obtain an initial channel estimation based on a wireless signal received over the wireless channel, to process the initial channel estimation by a classifier neural network comprising obtaining a class of the wireless channel, to select a refinement neural network out of a plurality of refinement neural networks based on the obtained class, and to obtain a refined channel estimation comprising processing the initial channel estimation by the selected refinement neural network.

The exemplary device 600 may be configured to perform any of the methods described herein.

The examples herein are not to limit the present disclosure. There are many modifications and configurations, which may be used in addition or alternatively, as will be briefly described herein. This present disclosure can be used in any kind of device that is receiving signals over a wireless channel.

The methodologies described herein may be implemented by various means depending upon the application. For example, these methodologies may be implemented in hardware, operation system, firmware, software, or any combination of two or all of them. For a hardware implementation, any processing circuitry 620 may be used, which may comprise one or more processors. For example, the hardware may comprise one or more of application specific integrated circuits (ASICs), digital signal processors (DSPs), digital signal processing devices (DSPDs), programmable logic devices (PLDs), field programmable gate arrays (FPGAs), processors, controllers, any electronic devices, and/or other electronic circuitry units and/or elements designed to perform the functions described above.

If implemented as program code, the functions performed by the transmitting apparatus (device) may be stored as one or more instructions or code on a non-transitory computer readable storage medium such as the memory 610 or any other type of storage. The computer-readable media comprises physical computer storage media, which may be any available medium that can be accessed by the computer, or, in general by the processing circuitry 620. Such computer-readable media may comprise RAM, ROM, EEPROM, optical disk storage, magnetic disk storage, semiconductor storage, and/or other storage devices. Some non-limiting examples comprise compact disc (CD), CD-ROM, laser disc, optical disc, digital versatile disc (DVD), Blu-ray (BD) disc and/or the like. Combinations of different storage media are also possible—in other words, distributed and heterogeneous storage may be employed.

The embodiments and exemplary implementations mentioned herein show some non-limiting examples. It is understood that various modifications may be made without departing from the disclosed subject matter. For example, modifications may be made to adapt the examples to new systems and scenarios without departing from the central concept described herein.

Summarizing, some non-limiting embodiments in the present disclosure relate to obtaining a channel estimation for a wireless channel. An initial channel estimation is obtained based on a received wireless signal. The initial channel estimation is processed by a classifier neural network, comprising obtaining a class of the wireless channel. A refinement neural network is selected according to the obtained class. The initial channel estimation is processed by the selected refinement neural network to obtain a refined channel estimation.

According to a non-limiting embodiment, a method is provided for channel estimation for a wireless channel, comprising: obtaining an initial channel estimation based on a wireless signal received over the wireless channel; processing the initial channel estimation by a classifier neural network comprising obtaining a class of the wireless channel; selecting a refinement neural network out of a plurality of refinement neural networks based on the obtained class; and obtaining a refined channel estimation comprising processing the initial channel estimation by the selected refinement neural network.

In an exemplary non-limiting implementation, the obtaining of the initial channel estimation further comprises processing a received pilot symbol obtained from the wireless signal and a reference pilot symbol to obtain the initial channel estimation.

For example, each refinement neural network from the plurality of refinement neural networks corresponds to a model of a wireless channel.

In an exemplary non-limiting implementation, a channel model is based on one or more of an environment of the wireless network, a delay spread, and/or non-line-of-sight (NLOS) conditions and/or or line-of-sight (LOS) conditions.

For example, the method further comprises obtaining a compensated signal based on the refined channel estimation and the received wireless signal.

In an exemplary non-limiting implementation, the wireless channel is one of an IEEE 802.11 based wireless channel, or a 5G New Radio (NR) based wireless channel.

For example, a refinement neural network out of the plurality of refinement neural networks is trained to refine the channel estimation according to a corresponding channel model.

In an exemplary non-limiting implementation, a refinement neural network from the plurality of refinement neural networks and/or the classifier neural network is a feed forward neural network.

According to a non-limiting embodiment, an apparatus is provided for channel estimation for a wireless channel, the apparatus comprising processing circuitry configured to: obtain an initial channel estimation based on a wireless signal received over the wireless channel; process the initial channel estimation by a classifier neural network comprising obtaining a class of the wireless channel; select a refinement neural network out of a plurality of refinement neural networks based on the obtained class; and obtain a refined channel estimation comprising processing the initial channel estimation by the selected refinement neural network.

For example, the obtaining of the initial channel estimation further comprises processing a received pilot symbol obtained from the wireless signal and a reference pilot symbol to obtain the initial channel estimation.

In an exemplary non-limiting implementation, each refinement neural network from the plurality of refinement neural networks corresponds to a model of a wireless channel.

For example, a channel model is based on one or more of an environment of the wireless network, a delay spread, and/or non-line-of-sight (NLOS) conditions and/or line-of-sight (LOS) conditions.

In an exemplary non-limiting implementation, the apparatus is further configured to obtain a compensated signal based on the refined channel estimation and the received wireless signal. For example, the wireless channel is one of an IEEE 802.11 based wireless channel, or a 5G New Radio (NR) based wireless channel.

In an exemplary non-limiting implementation, a refinement neural network from the plurality of refinement neural networks is trained to refine the channel estimation according to a corresponding channel model.

For example, a refinement neural network out of the plurality of refinement neural networks and/or the classifier neural network is a feed forward neural network.

Moreover, the corresponding methods are provided comprising steps performed by any of the above-mentioned processing circuitry implementations.

Still further, a computer program is provided, stored on a non-transitory medium, and comprising code instructions which when executed by a computer, by one or more processors or by a processing circuitry, performs steps of any of the above-mentioned methods.

According to some non-limiting embodiments, the processing circuitry and/or the transceiver is embedded in an integrated circuit, IC.

Any of the apparatuses of the present disclosure may be embodied on an integrated chip.

Any of the above-mentioned embodiments and exemplary implementations may be combined.

Although the disclosed subject matter has been described in detail for the purpose of illustration based on what is currently considered to be practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the disclosure. For example, it is to be understood that the presently disclosed subject matter contemplates that, to the extent possible, one or more features of any embodiment can be combined with one or more features of any other embodiment.

1. A method for channel estimation for a wireless channel, comprising:
obtaining an initial channel estimation based on a wireless signal received over the wireless channel;
processing the initial channel estimation by a classifier neural network to obtain a class of the wireless channel;
selecting a refinement neural network from a plurality of refinement neural networks based on the class of the wireless channel;
obtaining a refined channel estimation in based on processing the initial channel estimation by the selected refinement neural network.

2. The method according to claim 1, wherein the obtaining of the initial channel estimation comprises:
processing a received pilot symbol obtained from the wireless signal and a reference pilot symbol to obtain the initial channel estimation.

3. The method according to claim 1, wherein:
each refinement neural network of the plurality of refinement neural networks corresponds to a respective channel model of a plurality of channel models of the wireless channel.

4. The method according to claim 3, wherein:
at least one channel model of the plurality of channel models is based on one or more of:
an environment of the wireless network,
a delay spread, and/or
non-line-of-sight (NLOS) conditions or line-of-sight (LOS) conditions.

5. The method according to claim 1, wherein the method further comprises:
obtaining a compensated signal based on the refined channel estimation and the received wireless signal.

6. The method according to claim 1, wherein the wireless channel is one of:
an IEEE 802.11 based wireless channel, or
a 5G New Radio (NR) based wireless channel.

7. The method according to claim 3, wherein at least one refinement neural network from the plurality of refinement neural networks is trained to refine the channel estimation according to the respective channel model.

8. The method according to claim 1, wherein at least one refinement neural network from the plurality of refinement neural networks and/or the classifier neural network is a feed forward neural network.

9. At least one non-transitory, computer-readable medium, comprising instructions that, when executed by at least one processor, cause the at least one processor to perform the method according to claim 1.

10. An apparatus for channel estimation for a wireless channel, the apparatus comprising processing circuitry configured to:
obtain an initial channel estimation based on a wireless signal received over the wireless channel;
process the initial channel estimation by a classifier neural network to obtain a class of the wireless channel;
select a refinement neural network from a plurality of refinement neural networks based on the class of the wireless channel;
obtain a refined channel estimation based on processing the initial channel estimation by the selected refinement neural network.

11. The apparatus according to claim 10, wherein the obtaining of the initial channel estimation comprises:
processing a received pilot symbol obtained from the wireless signal and a reference pilot symbol to obtain the initial channel estimation.

12. The apparatus according to claim 10, wherein:
each refinement neural network of the plurality of refinement neural networks corresponds to a respective channel model of a plurality of channel models of the wireless channel.

13. The apparatus according to claim 12, wherein:
at least one channel model of channel model of the plurality of channel models is based on one or more of:
an environment of the wireless network,
a delay spread, and/or
non-line-of-sight (NLOS) conditions or line-of-sight (LOS) conditions.

14. The apparatus according to claim 10, wherein the apparatus is further configured to:
obtain a compensated signal based on the refined channel estimation and the received wireless signal.

15. The apparatus according to claim 10, wherein the wireless channel is one of:
an IEEE 802.11 based wireless channel, or
a 5G New Radio (NR) based wireless channel.

16. The apparatus according to claim 12, wherein at least one refinement neural network from the plurality of refinement neural networks is trained to refine the channel estimation according to the respective channel model.

17. The apparatus according to claim 10, wherein at least one refinement neural network from the plurality of refinement neural networks and/or the classifier neural network is a feed forward neural network.
